(19) United States
(12) Patent Application Publication
(10) Pub. No.: US 2005/0235278 A1
(43) Pub. Date: Oct. 20, 2005

(54) Computer system with two operating system for automatically downloading updated information and method thereof

(76) Inventors: Tung-Peng Wu, Taipei (TW); Chi-Min Liu, Taipei (TW); Yu-Hao Chan, Taipei (TW); Sheng-Kai Shju, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/104,534

(22) Filed: Apr. 13, 2005

(30) Foreign Application Priority Data
Apr. 16, 2004 (TW) 093110732

(51) Int. Cl. G06F 9/44

(52) U.S. Cl. 717/168

(57) ABSTRACT

A computer system with two operating systems for automatically downloading updated information and method thereof are disclosed. A first operating system and a second operating system are installed in a computer system while the second operating system shares information and application programs of the first operating system with the first operating system. By a download unit of the first operating system, at least one piece of updated information is downloaded from a remote server unit. Then being executed in the second operating system, an interface unit of the second operating system converts the updated information into accessible and executable format of the second operating system, and then reads and executes the updated information automatically under the first operating system for upgrading the second operating system as well as application programs being used. Therefore, the application programs and the second operating system can be upgraded at any time to improve computer efficiency for providing users better service.

### BACKGROUND OF THE INVENTION

The present invention relates to a computer system with two operating systems for automatically downloading updated information and method thereof, especially to a computer system installed with two operating systems that downloads information form a remote end and upgrades the systems automatically so as to increase the efficiency of application programs in the computer system.

In the era of competition, computer has become an essential tool for people. Besides word processing, computers offer multiple functions such as drawings, calculation and communications. By the fast development of information technology nowadays, the computer system has more powerful applications including home appliances and entertainment, involved with our daily lives. Moreover, due to more attentions of leisure activities and entertainment, computers are also disposed with a multimedia player system for entertainment such as playing music, VCD, DVD, television programs or broadcasting for relieving pressure. Thus there is no need for people to buy new electronic products for entertainment. This is not only reduced the occupation of interior space but also the cost for electronic products.

Most of computer systems now are installed with Windows operating systems that are developed and supported by Microsoft—the world's largest software maker. Thus they can provide enough technical support in various libraries, drivers for peripherals, Man-Machine Interface, application programs, chips and platforms. Moreover, the products provide enterprise-class manageability, availability, reliability, compatibility and performance. Integrated programs meet administrative as well as organizational needs and reduce cost for support.

However, powerful system resources of Windows also increase its system loading. Thus this has negative effect on the system stability and booting speed. Even only a single application program is used, users still need to wait for a longer time to turn on the computer system. This causes waste of time. In a time of efficiency, users expect computer systems with high stability, lower resource consumption, short start-up times and low cost for system construction. Thus the Linux operating systems has developed with a bright and prosperous future Yet the Linux operating systems remain far behind the Windows in compatibility and popularity of supporting application programs.

Due to above problems, a prior art—Taiwanese application No. 093102237—architecture and method of operating system for sharing application programs are disclosed. A computer system is installed with a first operating system with high resource consumption and a second operating system with low resource consumption while the second operating system shares application programs of the first operating system with the first operating system. Thus when users want to manipulate one application program such as a multimedia playback program, they only need to initiate the second operating system to execute a multimedia playback program quickly and directly. There is no need to initiate the first operating system so as to reduce system resource consumption and boost efficiency of the computer system.

Owing to higher requirements and demand of users, driving programs, operating systems and application programs installed in computer systems need much maintenance and upgrade to satisfy users' needs. The second operating system installed in computer systems of prior art has difficulties or problems in downloading updated information for upgrading the second operating system or shared application programs due to faulty internet connection. Therefore, there is a need for providing users with computer systems for better service.

### SUMMARY OF THE INVENTION

Therefore it is a primary object of the present invention to provide an application program that downloads updated information under the first operating system and automatically upgrades the second operating system and application programs being installed and shared with the second operating system so as to improve the efficiency of the computer systems installed with two operating systems.

It is another object of the present invention to provide a computer system installed with two operating systems that downloads updated information effectively for efficiency improvements.

In order to achieve above objects, the present invention provides a computer system with two operating systems for automatically downloading updated information and method thereof. The computer system is installed with a first operating system having at least one application program and a second operating system with low resource consumption. The second operating system shares information and application programs of the first operating system with the first operating system. A download unit is installed in the first operating system for connection to a remote server unit and downloading at least one piece of updated information while the second operating system is installed with an interface unit. The method for automatically downloading in accordance with the present invention is as following steps: firstly, a basic input output system (BIOS) of the computer system is enabled to execute the first operating system for driving the download unit in connection with the remote server unit and downloading updated information. Then, the computer system enables the BIOS to boot the second operating system, the interface unit converts the updated information in the first operating system into an accessible and executable data format of the second operating system. At last, the updated information is read and is executed so as to upgrade application programs and the second operating system for optimizing the performance of the computer system.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment in accordance with the present invention;

FIG. 2 is a flowchart of an embodiment in accordance with the present invention; and

FIG. 3 is a block diagram of another embodiment in accordance with the present invention.

### DETAILED DESCRIPTION OF THE PREFFERED EMBODIMENT

A computer system in accordance with the present invention is installed with a first operating system and a second operating system. The first operating system is executed to download updated information remotely while by sharing the updated information with the first operating system, the second operating system reads and executes the updated information for upgrading the second operating system and application programs installed in or shared with the second operating system.

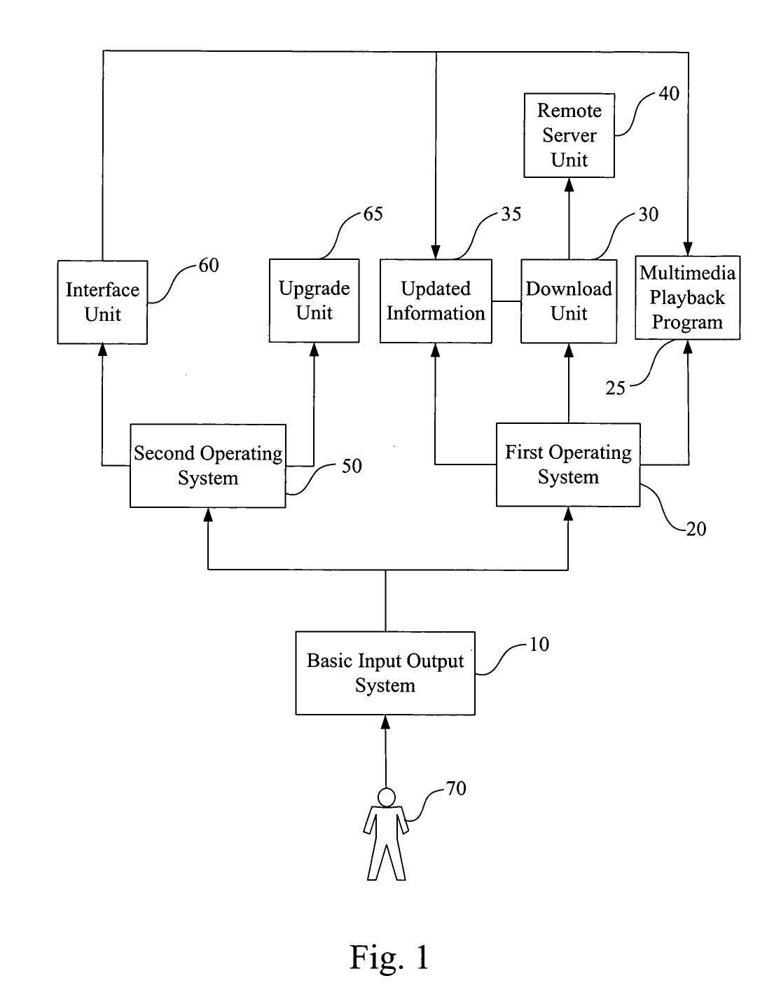

Refer to FIG. 1, a block diagram of an embodiment in accordance with the present invention is disclosed. A computer system of the present invention includes a basic input output system (BIOS) 10 for managing and controlling startup settings of the computer system; a first operating system 20 and a second operating system 50 installed in the computer system. The first operating system 20 with higher system resource consumption is installed with at least one application program such as multimedia playback program 25. The first operating system 20 is a FAT or a NTFS file format such as Windows operating systems—Windows XP, Windows NT, Windows 98, Windows 2000 and Windows Me. A download unit 30 installed in the first operating system 20 is connected to a remote server unit 40 so as to download at least one piece of updated information 35 from the remote server unit 40.

The second operating system 50 is a EXT2 or a EXT3 file format with low resource consumption such as Linux operating system. It can share updated information 35 and application programs such as a multimedia playback program 25 of the first operating system 20 with the first operating system 20. The multimedia playback program 25 is used to play CD, MP3, VCD, DVD, broadcasting, television programs and digital photographs. When the second operating system 50 shares application programs and updated information 35 with the first operating system 20, the second operating system 50 sends a command to an interface unit 60 that converts the updated information 35 of the first operating system 20 into readable and executable data format of the second operating system 50 for reading the updated information 35 so as to upgrade the second operating system 50 and application programs shared or executed by the second operating system 50. The upgrading operation is run by an upgrade unit 65 installed in the second operating system 50. Furthermore, while the second operating system 50 is run by the computer system of the present invention, the interface unit 60 can also convert the updated information 35 of the first operating system 20 automatically without the command from the second operating system 50.

The interface unit 60 of he present invention consists of a driving unit and a parameter converting unit disclosed in Taiwanese patent application No. 093102237. Through the interface unit 60, the second operating system 50 shares the updated information 35 of the first operating system 20 with the first operating system 20.

The purpose of the present invention to be installed with two operating systems is for reducing startup time by executing a single application program under the second operating system 50 when an user 70 only wants to apply a single application program. Moreover, the resource consumption of the computer system is also reduced. For example, when the user 70 wants to turn on the computer system for executing the multimedia playback program 25 to display audio/video data, music or broadcasting, the computer system only needs to execute the second operating system 50. By sharing the multimedia playback program 25 with the first operating system 20, the multimedia service is provided.

Thus the boot-up time of the computer system for executing the multimedia playback program 25 is reduced. Once the user 70 wants to execute multiple application programs, they can also start up the computer system by the first operating system 20 as general startup procedures.

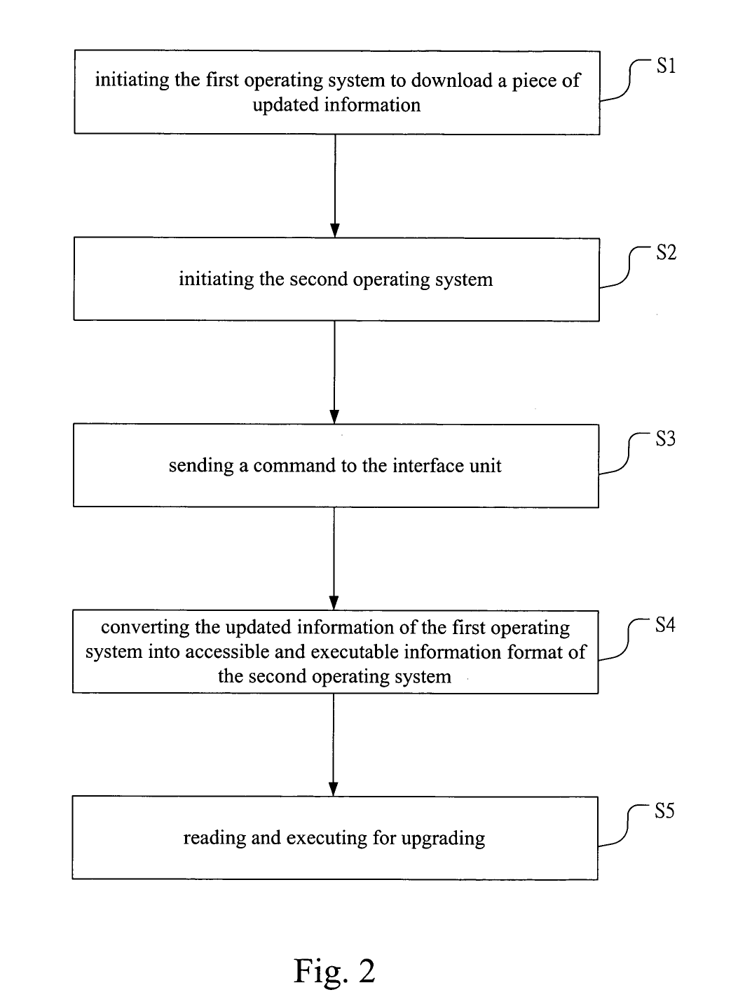

Refer to FIG. 2, a flowchart of an embodiment in accordance with the present invention is disclosed. When the user 70 of computers uses the first operating system 20 to manipulate the computer system, as shown in step S1, the basic input output system 10 initiates the first operating system 20 to be an operating system used after the computer system being turned on. Then the download unit 30 of the first operating system 20 is automatically connected to the remote server unit 40 for downloading at least one piece of updated information. At the same time of downloading information, the download unit 30 compares the updated information from the remote server unit 40 with the updated information 35 available now in the first operating system 20. If the updated information in the remote server unit 40 is a new version, it is downloaded and saved in the first operating system 20. The updated information 35 being downloaded is to upgrade the second operating system 50 and the application programs such as the multimedia playback program 25, being shared with or executed under the second operating system 50.

Later, when the user 70 would like to initiate the second operating system 50 for running a single application program, the basic input output system 10 takes the step S2 to execute the second operating system 50 for sending a command to the interface unit 60, as shown in step S3. After receiving the command, as shown in step S4, the interface unit 60 converts the updated information 35 of the first operating system 20 into accessible and executable information format of the second operating system 50. Then as shown in step S5, the updated information 35 is read and executed for upgrading the second operating system 50 or the shared application programs. Moreover, while reading and executing the updated information 35, the updated information 35 is compared with the information being used now by the second operating system 50 or application programs. Once the updated information 35 is a new version, the present invention continues the upgrading operations. Moreover, in above step S2, when the second operating system 50 is executed, the computer system can jump to step S4, without running the step S3, the interface unit 60 automatically converts the updated information 35 of the first operating system 20 into an accessible and executable information format of the second operating system 50.

The updated information 35 downloaded by the download unit 30 of the first operating system 20 is a file format consisting of a plurality of update files. While the second operating system 50 shares the updated information 35 with the first operating system 20, the updated information 35 is mounted on a point of a directory tree structure. Then the update files of the updated information 35 are executed for upgrading. The updated information 35 is used to upgrade the second operating system 50 and application programs being shared with such as the multimedia playback program 25 for displaying CD, MP3, DVD, VCD, broadcasting, television programs and digital photographs. After upgrading, the update files are unmounted-being detached from the mount point for system directory.

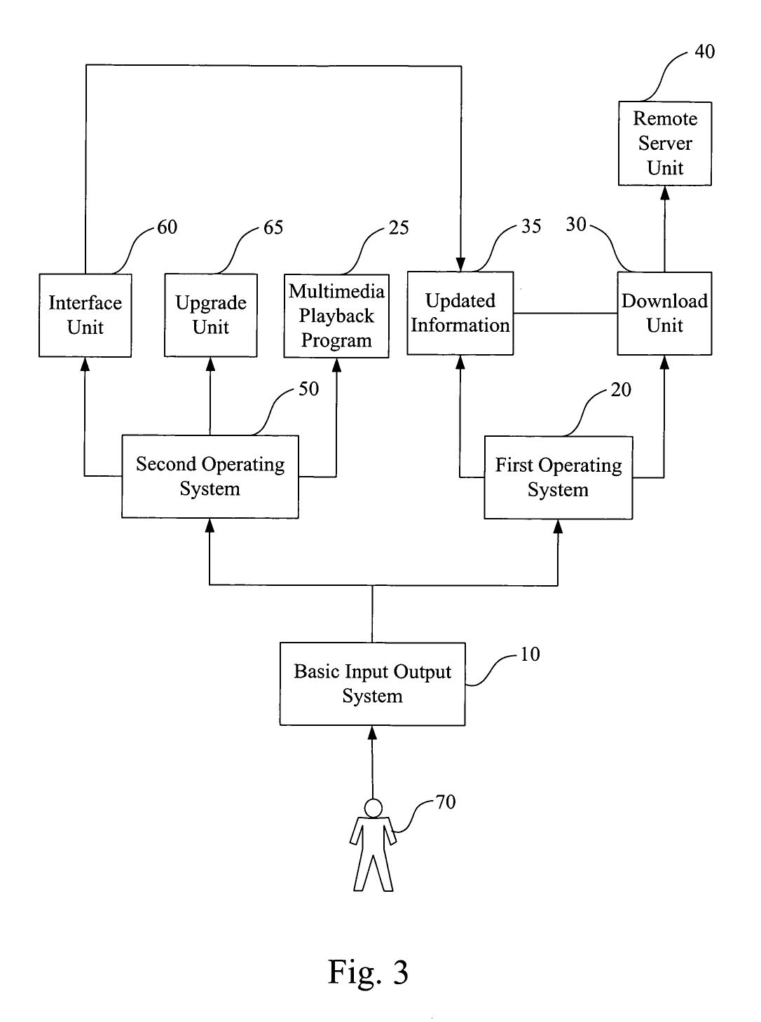

Refer to FIG. 3, a block diagram of another embodiment in accordance with the present invention is disclosed. The difference between this embodiment and the embodiment shown in FIG. 1 is in that the second operating system 50 is installed with at least one application program and the upgrade unit 65 of the second operating system 50 is able to upgrade application programs installed in the second operating system 50. As shown in figure, the application program is multimedia playback program 25.

In summary, a computer system with two operating systems for automatically downloading updated information and method thereof in accordance with the present invention take advantage of a first operating system 20 with sound network support to download updated information. Then when executing the second operating system 50 for running application programs, the upgrade unit 65 of the second operating system 50 automatically reads and executes the updated information 35 of the first operating system 20 so as to improve functions of the second operating system 50 as well as related application programs for providing users better service.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A computer system with two operating systems for automatically downloading updated information having a first operating system and a second operating system while the system resource consumption of the first operating system is higher than the system resource consumption of the second operating system; the computer system downloads at least one piece of updated information provided by a remote server unit; the computer system comprising:
a download unit installed in the first operating system for downloading the updated information from the remote server unit into the first operating system when the computer system runs the first operating system; and
an interface unit for converting the updated information into accessible and executable information format of the second operating system so as to process upgrading when the computer system executes the second operating system.

2. The computer system as claimed in claim 1, wherein the updated information is information for upgrading at least one application program of the first operating system.

3. The computer system as claimed in claim 1, wherein the updated information is information for upgrading the second operating system.

4. The computer system as claimed in claim 2, wherein the application program is a multimedia playback program.

5. The computer system as claimed in claim 1, wherein the second operating system is further installed with at least one application program and the updated information is information for upgrading the application program.

6. The computer system as claimed in claim 5, wherein the application program is a multimedia playback program.

7. The computer system as claimed in claim 4, wherein the multimedia playback program plays MPEG-1 Audio Layer 3 (MP3) music, compact disk (CD), digital versatile disc (DVD), Video Compact Disc (VCD), broadcasting, television programs, or digital photographs.

8. The computer system as claimed in claim 6, wherein the multimedia playback program plays MPEG-1 Audio Layer 3 (MP3) music, compact disk (CD), digital versatile disc (DVD), Video Compact Disc (VCD), broadcasting, Television programs, or digital photographs.

9. The computer system as claimed in claim 1, wherein the first operating system is a Windows operating system.

10. The computer system as claimed in claim 1, wherein the second operating system is Linux operating system.

11. The computer system as claimed in claim 1, wherein the second operating system further having an upgrade unit for upgrading and executing the updated information.

12. The computer system as claimed in claim 1, wherein the computer system further having a basic input output system for managing and controlling startup settings of the computer system as well as for executing the first operating system and the second operating system.

13. The computer system as claimed in claim 1, wherein the second operating system sends a command to the interface unit for converting the updated information into accessible and executable information format of the second operating system.

14. A method for a computer system with two operating systems for automatically downloading updated information, while the computer system is installed with a first operating system and a second operating system and the first operating system having higher system resource consumption than the second operating system, comprising the steps of:
executing the first operating system to download a piece of updated information remotely;
executing the second operating system for converting the updated information of the first operating system into accessible and executable information format of the second operating system; and
reading the updated information in the second operating system for upgrading.

15. The method as claimed in claim 14, wherein on step of executing the first operating system, a basic input output system of the computer system is enabled for executing the first operating system.

16. The method as claimed in claim 14, wherein on step of executing the second operating system, a basic input output system of the computer system is initiated for executing the second operating system.

17. The method as claimed in claim 14, wherein the updated information is information for upgrading the second operating system.

18. The method as claimed in claim 14, wherein the updated information is information for upgrading at least one application program of the first operating system.

19. The method as claimed in claim 18, wherein the application program is a multimedia playback program.

20. The method as claimed in claim 14, wherein the second operating system is further installed with at least one application program and the updated information is information for upgrading the application program.

21. The method as claimed in claim 20, wherein the application program is a multimedia playback program.

22. The method as claimed in claim 19, wherein the multimedia playback program plays MPEG-1 Audio Layer 3 (MP3) music, compact disk (CD), digital versatile disc (DVD), Video Compact Disc (VCD), broadcasting, television programs, or digital photographs.

23. The method as claimed in claim 21, wherein the multimedia playback program plays MPEG-1 Audio Layer 3 (MP3) music, compact disk (CD), digital versatile disc (DVD), Video Compact Disc (VCD), broadcasting, television programs, or digital photographs.

24. The method as claimed in claim 14, wherein the first operating system is a Windows operating system.

25. The method as claimed in claim 14, wherein the second operating system is a Linux operating system.

26. The method as claimed in claim 14, wherein on step of executing the first operating system to download a piece of updated information remotely, the updated information available now in the first operating system is compared with the updated information remotely and once the updated information remotely is a new version then the updated information remotely is downloaded into the first operating system.

27. The method as claimed in claim 14, wherein on step of reading the updated information in the second operating system for upgrading, the updated information available now in the first operating system is compared with the updated information being used by the computer system; once the updated information in the first operating system is a new version then updated information being used by the computer system is updated again.
